(19) United States
(12) Patent Application Publication
(10) Pub. No.: US 2003/0078858 A1
(43) Pub. Date: Apr. 24, 2003

(54) System and methods for peer-to-peer electronic commerce

(76) Inventors: Tom A. Angelopoulos, San Francisco, CA (US); Dathan Patishall, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/278,695

(22) Filed: Oct. 21, 2002

Related U.S. Application Data
(60) Provisional application No. 60/345,278, filed on Oct. 19, 2001.

(51) Int. Cl. G06F 17/60

(52) U.S. Cl. 705/26

(57) ABSTRACT

A system and methods for peer-to-peer electronic commerce between buyer and seller client systems facilitated by a server system. A buyer client system specifies search parameters for an offering that the user of the buyer client system desires to obtain. The buyer client system sends the search parameters of the desired offering to the server system. The server system maintains categories of offerings submitted from seller client systems. The server system determines the category of offering that corresponds to the search parameters. The server system then sends data identifying the seller client systems that have an offering in that category of offering to the buyer client system. Using the seller identification data, the buyer client system contacts the seller client system for information on the offering. The seller client system sends information on the offering to the buyer client system. The buyer and seller may discuss the information interactively and online using a chat or an online whiteboard system. If the user of the buyer client system desires to obtain the offering, the buyer client system sends a bid or a buy order to the seller client system.

### REFERENCE TO RELATED APPLICATION

The present application claims priority under 35 U.S.C. §119(e) from U.S. Provisional Application No. 60/345,278 filed Oct. 19, 2001, entitled “SYSTEM AND METHODS FOR PEER-TO-PEER ELECTRONIC COMMERCE,” which is incorporated herein by reference.

### BACKGROUND OF THE INVENTION

1. Field of the Invention

This invention relates to electronic commerce. More specifically, the invention provides a system and methods for peer-to-peer electronic commerce between computing devices.

2. Description of the Related Art

Advancements in computer technology and the Internet have enabled individuals, businesses and other organizations to communicate more effectively. The Internet provides for a vast amount of data to be disseminated on a global basis. Several electronic commerce systems have emerged to allow consumers and businesses to enter intro commercial transactions over the Internet. However, these electronic commerce systems have several disadvantages. In particular, these systems depend on a client-server topology which places undue stress on servers and the network. Moreover, the servers used in electronic commerce are burdened with maintaining and updating an inventory of goods for sale, and thus, if a server is rendered inoperative, the electronic commerce system becomes ineffective. Also, the server systems are burdened with substantial interaction with the buyers and sellers, which increases-network traffic to the server systems. Such burdens on the server system sometimes causes the server system or the network to shut-down, resulting in a halt in the electronic commerce system until the problem is rectified.

Several peer-to-peer systems have emerged to address the disadvantages of client-server systems. The peer-to-peer systems generally require the server system to maintain an inventory listing of offerings available. The client systems search these inventory listings for desired offerings. However, this system is disadvantageous as it is dependent on the server system to facilitate the electronic commerce. For example, if the server system is inoperative, the client systems cannot access the inventory listing, and since that information is not available elsewhere, the client systems cannot conduct commerce with each other.

Therefore, there exists a need for a more effective system and method of electronic commerce over computing networks.

### SUMMARY OF THE INVENTION

The present invention relates to electronic commerce. Generally, electronic commerce, or “e-commerce”, refers to the buying and selling of products and services by businesses and consumers over a computer network, such as the Internet. The current e-commerce computer systems are based on a client-server topology, where a server system essentially manages the e-commerce system by maintaining an inventory and managing communication with client systems. Today's client computer systems possess a great amount of processing power and memory; therefore, this processing power and memory is not fully exploited if the server system performs the majority of the operations of the electronic commerce system. One embodiment of the invention is an electronic commerce system using peer-to-peer networking.

One aspect of the invention is a method of performing a transaction, comprising receiving item information associated with items for sale from a plurality of seller client systems, maintaining the item information on a server system, maintaining identifications of each of the seller client systems associated with each of the items for sale on the server system, receiving a query from a buyer client system, wherein the query comprises search criteria for a desired item for purchase, preparing a list of identifications of each of the seller client systems that satisfy the search criteria, and sending the list of identifications of each of the seller client systems to the buyer client system.

Another aspect of the invention is a method of performing electronic commerce over a computer network, comprising maintaining a data structure comprising a list of categories of offerings by a plurality of seller client systems, receiving a query from a buyer client system, wherein the query comprises a search criteria, determining an offering category associated with the search criteria, preparing a list of one or more of said seller client systems associated with the offering category, and sending the list of one or more of said seller client systems to the buyer client system.

Another aspect of the invention is a method of locating an offering over a computer network, comprising defining a search criteria associated with the offering, sending the search criteria over the computer network to a server system, receiving a list of one or more seller client systems associated with the search criteria, sending a query to one of the one or more seller client systems requesting information on an offering for sale satisfying the search criteria, and receiving information on the offering for sale from the seller client system.

Another aspect of the invention is a method of placing an offering for acquisition over a computer network, comprising assigning one of a plurality of offering category designations to the offering, sending the assigned offering category designation over the computer network to a server system, and receiving a query from a buyer client system requesting information associated with the offering.

Another aspect of the invention is a method of placing offerings for sale over a computer network, comprising assigning one of a plurality of offering category designations to each of one or more offerings for sale, sending the assigned offering category designation over the computer network to a server system, and receiving a query from a buyer client system requesting information associated with a selected one of the offering category designations.

Another aspect of the invention is a computer system for performing a sales transaction, comprising a plurality of seller client systems each identified by a seller client system identifier, a plurality of offerings associated with one of the seller client systems, a plurality of categories of offerings, each of the offerings being associated with at least one of the offerings, a buyer client system, and a server system comprising a category of offerings data structure comprising one or more of said categories of offerings and one or more of said seller client system identifiers, wherein the buyer client system is configured to send a query to the server system to locate a desired offering, the server system is configured to determine at least one of the categories of offerings satisfying the query, the server system is further configured to query the category of offerings data structure to determine a list of send the seller client system identifiers associated with the determined at least one category, and the server is further configured to send the list of seller client system identifiers to the buyer client system.

Another aspect of the invention is a computer system for performing a commerce transaction, comprising a communications module configured to receive offering information associated with an offering from one of a plurality of seller client systems, wherein each seller client system is identified by a seller client system identifier, a category of offerings data structure comprising one or more offering categories and one or more of said seller client system identifiers, and a control module configured to maintain the category of offerings data structure, wherein the control module is further configured to provide one or more of said seller client system identifiers to a buyer client system in response to a query from the buyer client system.

Another aspect of the invention is a computer system for performing a commerce transaction, comprising offering information associated with an offering, and a communications module configured to send the offering information to a server system and to receive a buy order or an auction bid directly from a buyer client system.

Another aspect of the invention is a computer system for performing a commerce transaction, comprising a query comprising offering information describing a desired offering, and a communications module configured to send the query to a server system, wherein the communications module is further configured to receive one or more seller client system identifiers associated with the offering information from the server system.

### BRIEF DESCRIPTION OF THE DRAWINGS

FIG. 1 illustrates a block diagram of a peer-to-peer network system, according to aspects of an embodiment of the invention;

FIG. 2 illustrates a block diagram of a client system and a server system, according to aspects of an embodiment of the invention;

FIG. 3 illustrates a block diagram of a server system data structure, according to aspects of an embodiment of the invention;

FIG. 4 illustrates a block diagram of a client system data structure, according to aspects of an embodiment of the invention;

FIG. 5a illustrates a process flow diagram of the addition of an offering by a client system process, according to aspects of an embodiment of the invention;

FIG. 5b illustrates a process flow diagram of a deletion of an offering by a client system process, according to aspects of an embodiment of the invention;

FIG. 6 illustrates a process flow diagram of a search for an offering process, according to aspects of an embodiment of the invention;

FIG. 7 illustrates a sample screen display of a log-in screen, according to aspects of an embodiment of the invention;

FIG. 8 illustrates a sample screen display of a query screen, according to aspects of an embodiment of the invention;

FIG. 9 illustrates a sample screen display of an offering display screen, according to aspects of an embodiment of the invention;

FIG. 10 illustrates a sample screen display of an online chat screen, according to aspects of an embodiment of the invention; and

FIG. 11 illustrates a sample screen display of an online whiteboard screen, according to aspects of an embodiment of the invention.

### DETAILED DESCRIPTION OF THE PREFERRED EMBODIMENT

The features of the systems and methods will now be described with reference to the drawings summarized above. Throughout the drawings, reference numbers are re-used to indicate correspondence between referenced elements. In addition, the first digit of each reference number indicates the figure in which the element first appears. The drawings, associated descriptions, and specific implementation are provided to illustrate embodiments of the invention, and not to limit the scope of the invention. The scope of the invention is defined by the appended claims.

### I. Overview

The present invention relates to electronic commerce. Generally, electronic commerce, or “e-commerce”, refers to the buying and selling of products and services by businesses and consumers over a computer network, such as the Internet. Previously, electronic commerce has been described in relation to the parties that performed the transaction, and thus, electronic commerce was divided into at least three categories: business to business (“B2B”), business to consumer (“B2C”), and consumer to consumer (“C2C”). Examples of business to consumer electronic commerce include Amazon.com ®, and examples of consumer to consumer electronic commerce include eBay ®.

Generally, electronic commerce systems are implemented through a client-server architecture. Client-server architecture is a computational architecture that involves client processes requesting service from server processes. Thus, when implemented in electronic commerce, information regarding offerings, sale terms, sellers, and buyers is maintained on a server system and accessed by client computer systems; essentially, the electronic commerce transaction takes place through the server system.

One embodiment of the invention is an electronic commerce system using peer-to-peer networking. Peer-to-peer networking is a communications model in which each participating computer system has roughly the same capabilities as any other participating computer system, and can initiate a communication session with another participating computer system that has allowed for such communication. Each computer system using the peer-to-peer communications system is referred to as a “communication node” or “node”. In some cases, peer-to-peer communications is implemented by giving each communication node both server and client capabilities. Peer-to-peer networking has been used to allow communication nodes to exchange files with each other directly or through a mediating server. In one embodiment, the invention advantageously utilizes peer-to-peer networking to facilitate electronic commerce with respect to various offerings.

As used herein, the term “offering” refers to goods, services, data, information, advertisement, personal ads, classifieds, and any other form of data or entity, tangible or intangible, that may be the subject of an electronic commerce transaction, whether for value or not. An offering may be grouped in a category of similar offerings and referred to as an “offering category”. For example, an offering to sell a particular car may be categorized in the offering category “cars” or “vehicles.” Similarly, an offering to provide computer consulting services may be categorized in the offering category “consulting services.” Offerings may be placed for sale, acquisition, exchange, auction, or any form of transaction. An auction includes any type of auction, such as, for example, a classic auction where one or more potential buyers bid on a particular item, a Dutch auction where one or more potential buyers bid on multiple quantities of the same item, and the like.

### II. Peer-To-Peer Electronic Commerce

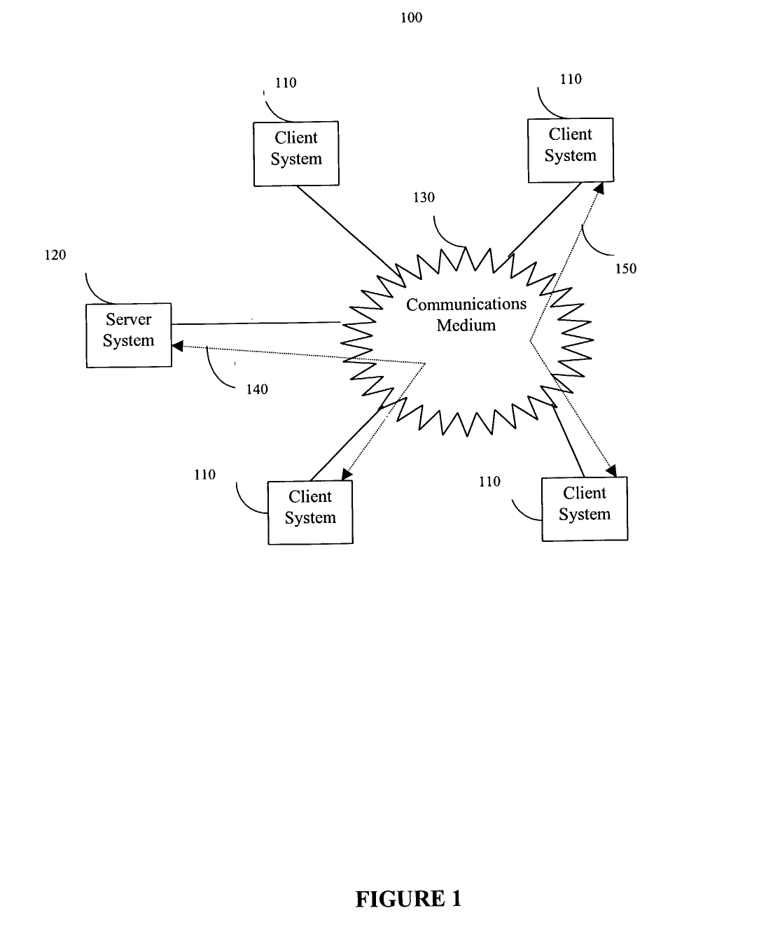

FIG. 1 illustrates a block diagram of a peer-to-peer network system 100, according to aspects of an embodiment of the invention. As illustrated in FIG. 1, the peer-to-peer network system 100 comprises one or more client systems 110 communicating with one or more server systems 120 through a communications medium 130. Also as illustrated in FIG. 1, the peer-to-peer network system 100 enables communication between the client system 110 and the server system 120 through a client-to-server data path 140 while also enabling communication between any client system 110 and another client system 110 through a peer-to-peer data path 150.

A. Client System

In one embodiment, the client system 110 comprises a computer device that enables the client system 110 to communicate with other client systems 110 and the server system 120. The computer device may be a general purpose computer using one or more microprocessors, such as, for example, a Pentium ® processor, a Pentium II ® processor, a Pentium Pro ® processor, a Pentium IV ® processor, an ×86 processor, an 8051 processor, a MIPS processor, a Power, PC ® processor, a SPARC ® processor, an Alpha ® processor, and so forth. The computer may also be a Personal Digital Assistant (“PDA”) such as, for example, the Zaurus ® Linux-based PDA commercially available from Sharp ®, the iPaq ® Windows CE-based PDA commercially available from Compaq Corporation ®, and the like.

In one embodiment, the client system 110 comprises a processor unit that runs a computer operating system such as the Microsoft® Windows NT operating system and performs standard operating system functions. It is recognized that other operating systems may be used, such as, for example, Microsoft® Windows® 3.X, Microsoft® Windows 98, Microsoft® Windows® 2000, Microsoft® Windows® 95, Microsoft® Windows® CE, Microsoft® Windows® ME, Palm Pilot OS, Apple® MacOS®, Disk Operating System (DOS), UNIX, IRIX, Solaris, SunOS, FreeBSD, Linux®, IBM® OS/2® operating systems, and so forth.

In one embodiment, the client system 110 is equipped with network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example NFS v2/v3 over UDP/TCP, Microsoft® CIFS, HTTP 1.0, HTTP. 1.1, DAFS, FTP, wireless network protocols, and so forth.

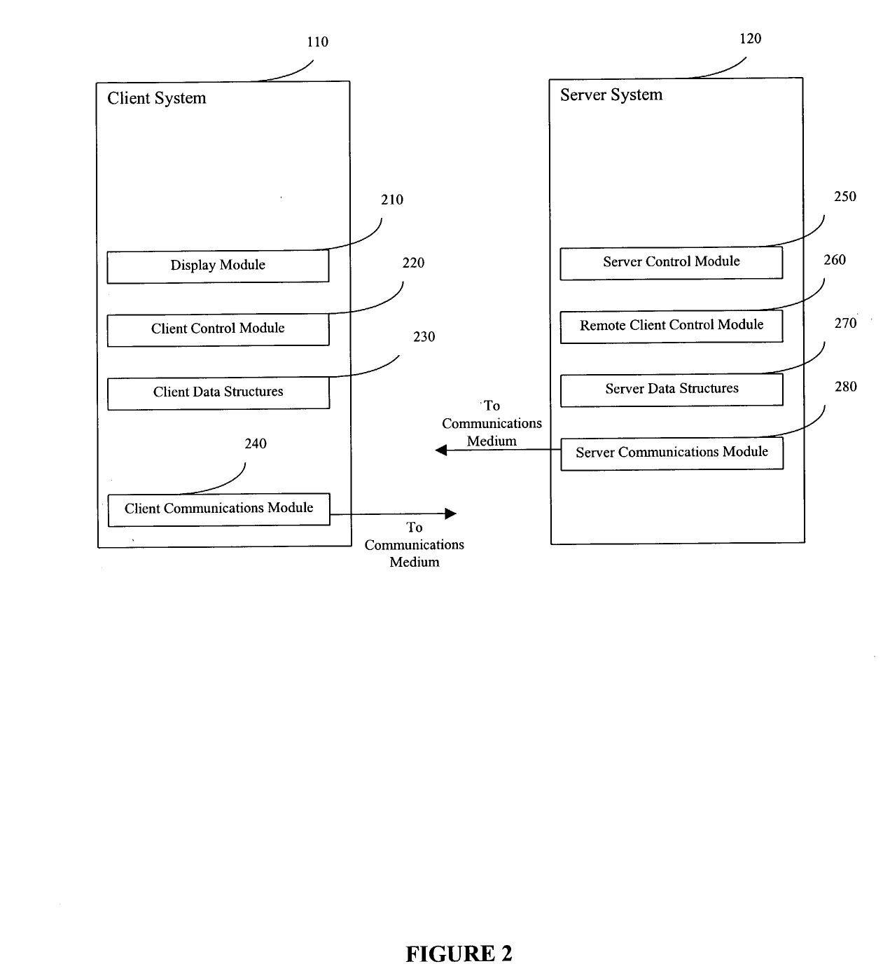

FIG. 2 illustrates a block diagram of the client system 110, according to aspects of an embodiment of the invention. As illustrated in FIG. 2, the client system 110 comprises a display module 210, a client control module 220, client data structures 230, and a client communications module 240.

As used herein, the word “module”, whether in upper or lower case letters, refers to logic that may be embodied in hardware or in firmware, or to a collection of software instructions, possibly having entry and exit points, written in a programming language, such as, for example, C++. A software module may be compiled and linked into an executable program, included in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may comprise connected logic units, such as gates and flip-flops, and/or may comprise programmable units, such as programmable gate arrays or processors. The modules described herein are preferably implemented as software modules, but may be represented in hardware or firmware.

As used herein, the term “user” refers to an individual, group, organization, business, or any other entity that uses the client system 110. Further, a client system used to search for, purchase, or bid on, offerings may be referred to as a “buyer client system” and the user as the “buyer,” while a client system used to place offerings on sale, display, or on auction, may be referred to as a “seller client system” and the user as the “seller.” As it can be seen, in some situations a client computer system may be both a buyer client system and a seller client system—for example, where the client system has an offering for sale and is also looking to purchase an offering.

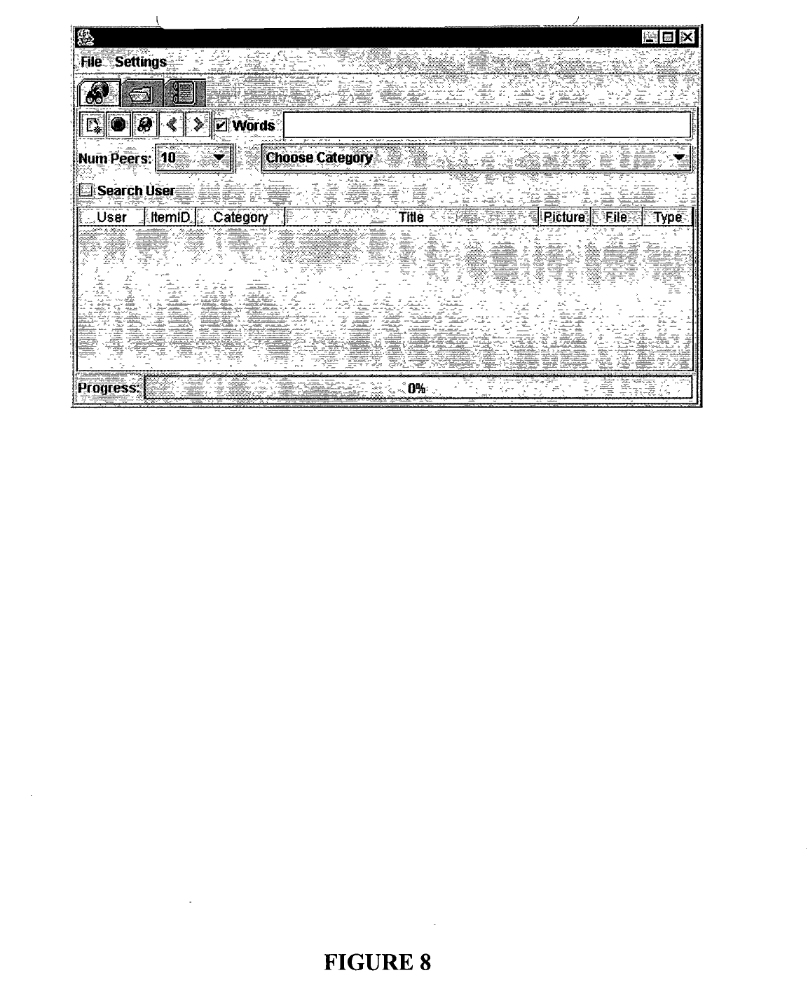

In one embodiment, the display module 210 comprises any computer processes, computer software, or computer device capable of displaying data to or obtaining data from the user. Data may include any information communicated to the user, and may include a variety of data formats, such as, for example, text, graphics, hyperlinks, video, voice, image, flash, audio, visual, and so forth. The display module 210 may comprise a user interface system capable of displaying data to the user and receiving input from the user. For example, the display module 210 may comprise a graphical user interface (“GUI”), a text-based interface, and the like. FIG. 8 illustrates a sample screen display of a user interface, according to aspects of an embodiment of the invention.

In another embodiment, the display module 210 may comprise an Internet browser system or software program. Generally, a browser is a computer application program that provides a way to look at and interact with the information provided through the World Wide Web (the “Web”). Also, a browser is usually a client program that uses Hypertext Transfer Protocol (“HTTP”) to make requests of Web servers throughout the Internet on behalf of the browser user. Examples of browsers include Internet Explorer ® commercially available from Microsoft Corporation ®, Netscape Navigator ®, Mosaic ®, and the like. A browser may also be available through an Internet access provider such as AOL ®. As yet another example of a browser, Lynx ® is a text-only browser for UNIX shell users.

In yet another embodiment, the display module 210 may comprise a command line interface enabling the user to input data, and receive data, without a graphical user interface. As it can be seen, the display module 210 may comprise various forms of computer processes, computer software, or computer device capable of displaying data to or obtaining data from the user, and the invention is not meant to be limited by a particular type of interface.

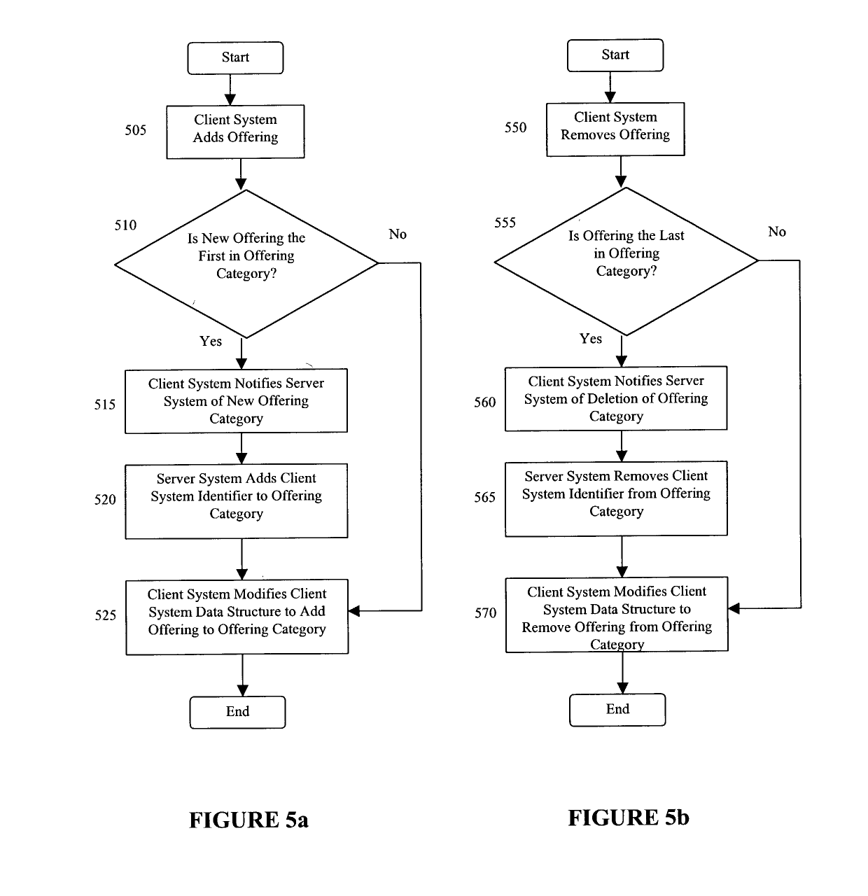

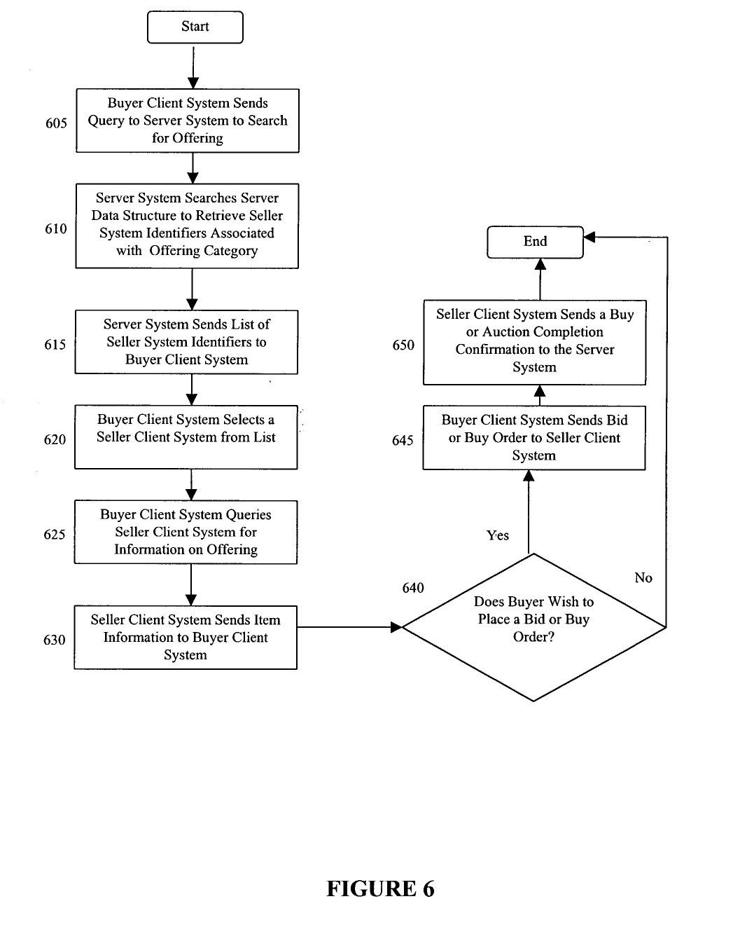

In one embodiment, the client control module 220 comprises computer processes, computer programs, and computer devices that carry out the functions of the client system 110. For example, the client control module 220 may comprise software that operates the client system 110, the peer-to-peer functionality, electronic commerce or auction logic, database and data structure maintenance and the like. As another example, the client control module 220 may comprise software to maintain and update the client data structures 230, including the addition, deletion, and updating of offerings as illustrated herein with reference to FIGS. 5a and 5b. As another example, the client control module 220 may comprise software to respond to a search request by another client system 110 by preparing a description of offerings for the other client system 110. Specifically, in one embodiment, the client control module 220 sends a list of offerings and descriptions of the offerings to the buyer client system in response to receiving an offering category from the buyer client system. This process is further described in reference to FIG. 6. As yet another example, the client control module 220 may comprise software to send buy order confirmations or auction completion confirmations from a seller client system to the server system 120. Some of the processes performed by the client control module 220 are further described in reference to FIGS. 5a, 5b, and 6.

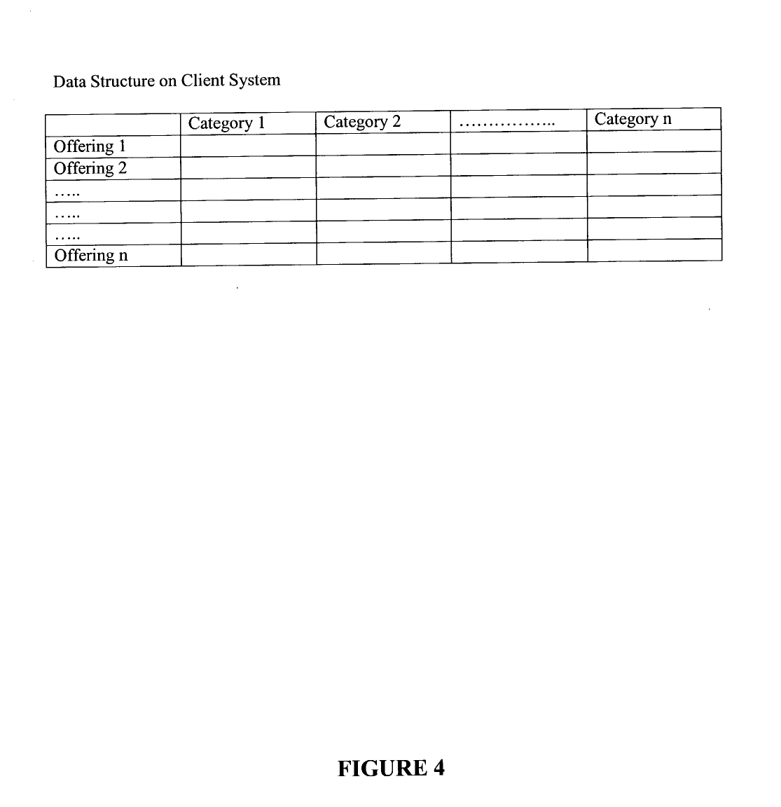

In one embodiment of the invention, the client data structures 230 comprises data structures, databases, computer software, and/or other data schemes and systems to maintain and update data on the client system 110. The client data structure 230 comprises data on the offerings of the client system 110, data on the user of the client system 110, and/or other data to facilitate electronic commerce. For example, the client data structure 230 may contain data on or links to an offering's description, asking price, and the offering category associated with the offering. The offering's description may include text, image, audio, video, and other data. The client data structures 230 are described further with reference to FIG. 4.

In one embodiment, the client communications module 240 comprises computer devices and processes that provide a computer device with communication capability or network connectivity. The client communications module 240 may utilize network connectivity technology such as, for example, Ethernet (IEEE 802.3), Token Ring (IEEE 802.5), Fiber Distributed Datalink Interface (FDDI), or Asynchronous Transfer Mode (ATM). Further, the client communications module 240 may be configured to support a variety of network protocols such as, for example NFS v2/v3 over UDP/TCP, Microsoft® CIFS, HTTP 1.0, HTTP. 1.1, DAFS, and FTP. As illustrated in FIG. 2, the client communications module 240 enables communication between the client system 110 and the communications medium 130. Therefore, the client communications module 240 enables the client system 110 to communicate with other client systems 110 and the server system 120 through the communications medium 130.

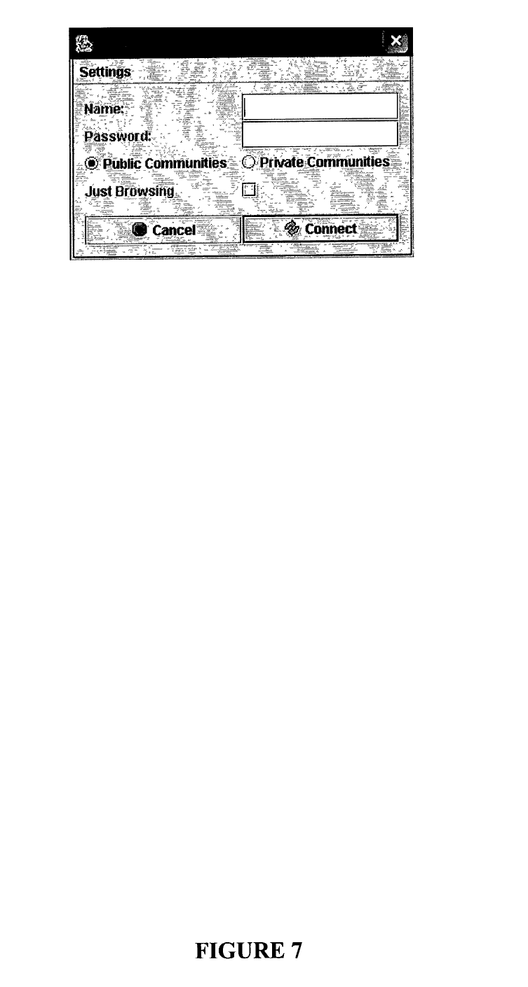

In one embodiment of the invention, the client system 110 connects to the server system 120 through a login process or any other secured or unsecured access process. FIG. 7 illustrates a sample screen display of a log-in screen, according to aspects of an embodiment of the invention. As illustrated in FIG. 7, the user enters a user name and a password to gain access to the server system 120. The user name and password may be assigned to the user in a variety of ways, including online registration, pre-assigned registration, and the like. Once the user has entered the required information, the user presses the “Connect” button, prompting the client system 110 to contact the server system 120 to establish a connection.

B. Server System

In one embodiment, the server system 120 runs on a computer that enables the server system 120 to communicate with the client system 110. The computer may be a general purpose computer using one or more microprocessors, such as, for example, a Pentium ® processor, a Pentium II ® processor, a Pentium Pro ® processor, a Pentium IV ® processor, an ×86 processor, an 8051 processor, a MIPS processor, a Power PC ® processor, a SPARC ® processor, an Alpha ® processor, and so forth.

In one embodiment, the processor unit of the server system 120 runs the Microsoft® Windows NT operating system and performs standard operating system functions. It is recognized that other operating systems may be used, such as, for example, Microsoft® Windows® 3.X, Microsoft® Windows 98, Microsoft® Windows® 2000, Microsoft® Windows® 95, Microsoft® Windows® CE, Microsoft® Windows® ME, Palm Pilot OS, Apple® MacOS®, Disk Operating System (“DOS”), UNIX, IRIX, Solaris, SunOS, FreeBSD, Linux®, IBM® OS/2® operating systems, and so forth.

In one embodiment, the computer is equipped with network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example NFS v2/v3 over UDP/TCP, Microsoft® CIFS, HTTP 1.0, HTTP. 1.1, DAFS, and FTP.

FIG. 2 illustrates a block diagram of the server system 120, according to aspects of an embodiment of the invention. As illustrated in FIG. 2, the server system comprises a server control module 250, a remote client control module 260, server data structures 270, and a server communications module 280.

In one embodiment, the server control module 250 comprises computer processes, computer programs, and computer devices to carry out the functions of the server system 120. For example, the server control module 250 may comprise software that operates the server system 120, the peer-to-peer functionality, electronic commerce or auction logic, database and data structure maintenance and the like. As another example, the server control module 250 may comprise software to maintain and update the server data structures 270, including the updating of categories of offerings as illustrated herein with reference to FIGS. 5a and 5b and updating client system identifiers. As another example, the server control module 250 may comprise software to respond to a search request by the client system 110 by preparing a list of other client systems 110 that have offerings in the offering category satisfying the search request and sending the list to the client system. As yet another example, the server control module 250 may comprise software to receive buy order confirmations or auction completion confirmations from a seller client system and to maintain that information in the server system 120. Some of the processes performed by the server control module 250 are further described in reference to FIGS. 5a, 5b, and 6.

In one embodiment, the remote client control module 260 comprises computer processes, computer programs, and computer devices to carry out the instructions of the client system 110 that desires to access the processes of the server system 120 through the use of an Internet browser. In this scenario, the client system 110 is not using the client control module 220 to perform peer-to-peer electronic commerce, but rather, the client system 110 is using an Internet browser to access the server system 120 and perform peer-to-peer electronic commerce through the computer processes and software contained on the server system 120. Since an Internet browser is generally a client program without electronic commerce functions, the remote client control module 260 provides the software and processes to perform peer-to-peer electronic commerce. In one embodiment, the client system 110 utilizes an applet, either residing on the clients system 110 or received from the server system 120, in conjunction with the Internet browser to access the server system 120, communicate with other client systems 110, or perform other electronic commerce functions. Generally, an applet is a smaller computer program that can be sent along with a Web page to a user. For example, Java ® applets can perform interactive animations, immediate calculations, or other simple tasks without having to send a user request back to the server.

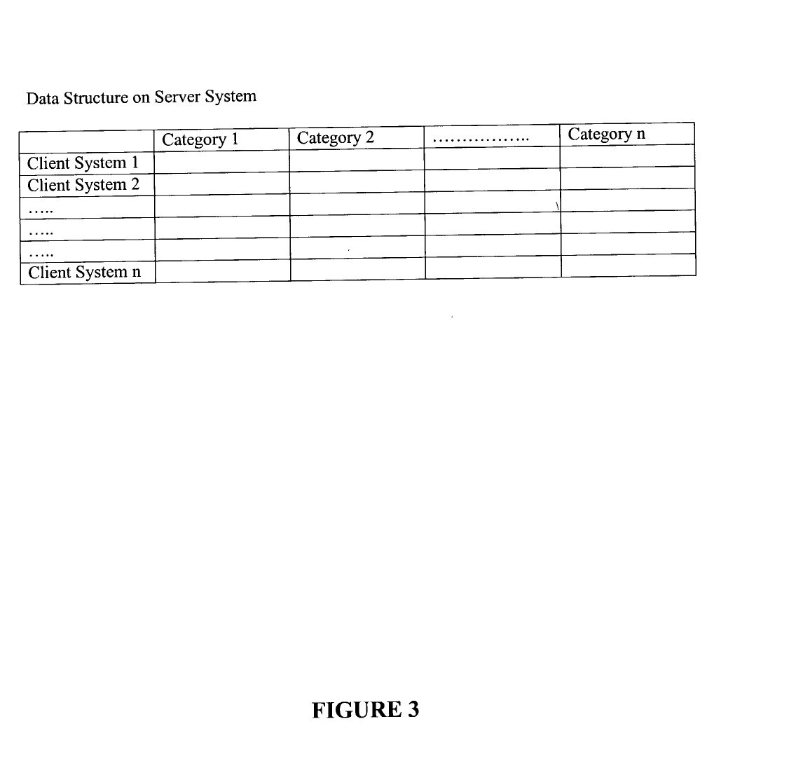

In one embodiment of the invention, the server data structures 270 comprises data structures, databases, computer software, and other data schemes and systems to maintain and update data on the server system 120. The server data structures 270 comprises data on the offering categories from one or more client systems 110, identification data on the client systems 110 (“client system identifiers”) that are providing offerings and/or and other data to facilitate electronic commerce. For example, the server data structures 270 may contain data describing an offering category, data to identify the client systems 110 having an offering in the offering category, and the like. The offering category's description may include text, image, audio, video, and other data. The data that identifies the client system 110 may include an Internet Protocol (“IP”) address that uniquely identifies each client system 110. The server system 120 may also maintain credit card, and other payment types, information associated with the client systems 110 that have an offering available. The data that identifies the client system 110 may also include other information about the client system 110, such as, for example, user name, network connection speed, location of the client system 110, email address, and the like. The server data structures 270 are described further with reference to FIG. 3.

In one embodiment, the server communications module 280 comprises computer devices and processes that provide a computer device with communication capability or network connectivity. The server communications module 280 may utilize network connectivity technology such as, for example, Ethernet (IEEE 802.3), Token Ring (IEEE 802.5), Fiber Distributed Datalink Interface (FDDI), or Asynchronous Transfer Mode (ATM). Further, the server communications module 280 may be configured to support a variety of network protocols such as, for example NFS v2/v3 over UDP/TCP, Microsoft® CIFS, HTTP 1.0, HTTP. 1.1, DAFS, and FTP. As illustrated in FIG. 2, the server communications modules 280 enables communication between the server system 120 and the communications medium 130, and therefore, the server communications module 280 enables the server system 120 to communicate with one or more client systems 110 through the communications medium 130.

1. Multi-Server Structure and Communities

In one embodiment of the invention, the server system 120 comprises one or more master server systems, with each master server associated with one or more slave servers. In one embodiment, the slave servers comprise server systems configured to facilitate electronic commerce for one category of offering. For example, a slave server system may facilitate only electronic commerce relating to auctioning automobiles, antiques, exchange of personal ads, and the like. A server system configured to facilitate electronic commerce for one category of offering may be referred to as a “community server,” and the offerings and users associated with buying, selling, or exchange of the offerings may be referred to generally as a “community.” A community may be private (accessible by a closed set of users) or public (accessible by the public.) Moreover, the community server may limit the number of users that may access the community. A slave server system may also be configured to maintained more than one community. Data relating to the community may be maintained on a server, a client, or both, and the data may be kept in various formats, such as, for example, the eXtendible Markup Language (“XML”.)

The master server system may be referred to as a “gateway.” In one embodiment, when a user accesses the gateway, the gateway presents the user with a list of communities that the user may access. Once the user has selected a community, the slave server system, or the community server, associated with that community becomes the user's main server and facilitates the user's interaction with the community. When a user is a member of a community, searches performed by the user are performed within that community; however, a user may join one or more communities and perform searches in each community.

The multi-server design and communities have several advantages. First, the computer processor and network demands are distributed over several servers, making the system more efficient and reliable. Further each server system will require less hardware and processing powers as a result. Second, multi-server design allows for the electronic commerce system to be more scalable. For example, when demands grows for a new community, that community may be set-up by the addition of another slave server system dedicate to the new community without the modification of other slave server systems.

In one embodiment, the gateway facilitates access by users. The gateway performs the log-in process and controls secured access to the communities. FIG. 7 illustrates a sample screen display of a log-in screen, according to aspects of an embodiment of the invention. The gateway utilizes the log-in screen to obtain log-in information from the user in order to provide the user with access to a community. As illustrated in FIG. 7, the user is asked to enter a username and password, select the type of community to access, and to state whether the user is planning to only browse the offerings. An advantage of requiring passwords from users is so the server system may control the formation of communities. Once a user logs on successfully, the gateway presents the user with a list of communities to join. Once the user selects a community, the gateway server channels the user to that community. In one embodiment, the information regarding a user's username and password is maintained on the gateway in a secured manner.

C. Communications Medium

Focusing now on the communications medium 130, the presently preferred communication medium 130 may include the Internet. Generally, the Internet is a wide-area network with routing hubs and domain name system (DNS) servers, as is well known in the art. DNS is a Transfer Control Protocol/Internet protocol (TCP/IP) service translates domain names to and from Internet Protocol (IP) addresses. The routing hubs connect to one or more other routing hubs via high-speed communication links. One popular part of the Internet is the World Wide Web (the “Web”) which includes different computers which store electronic Web documents via their Web sites. The term “site” is not intended to imply a single geographic location, as a Web site or other network site can, for example, include multiple geographically distributed computer systems that are appropriately linked together. Generally, the electronic Web documents may display a variety of data such as, graphical images, audio, video, and so forth.

One of ordinary skill in the art will recognize that a wide range of interactive communications mediums may be employed in the invention. For example, the communications medium 130 may include interactive television networks, telephone networks, wireless networks, wireline networks, cellular networks, wireless data transmission systems, two-way cable systems, customized computer networks, interactive kiosk networks, local area networks, wide area networks, satellite networks, intranet networks, broadband networks, baseband networks, and the like, as well as any combination of the above.

### III. Data Management in Electronic Commerce

An important aspect of electronic commerce is the management of data involved in offerings and transactions. One aspect of the invention allows for more of the data relating to the client systems 110 and their offerings to be managed on the client systems 110. Advantageously, in one embodiment of the invention, the server system 120 does not maintain an inventory of offerings, which allows the server system 120 to require less memory, processing power, and maintenance. Further, by not maintaining an offering inventory on the server system 120, the client systems 110 are less reliant on the server system 120 and can perform electronic commerce with other client systems 110 even when the server system 120 is inoperative.

The invention advantageously maintains data structures on the client system 110 and the server system 120 to improve the performance of an electronic commerce system, facilitate electronic commerce even when the server system 120 is inoperative, to minimize hardware costs of the server system 120, and to minimize computer software and computer processor requirements placed on the server system 120.

A. Server System Data Structures

FIG. 3 schematically illustrates a server system data structure, according to aspects of an embodiment of the invention. As illustrated in FIG. 3, the server system 120 maintains data on each offering category and a client system identifier identifying all of the client systems that have offerings in that offering category. The client system identifier may comprise any data or method of identifying a client system, such as, for example, an IP address. The data structure facilitates the identification of all of those client systems 110 that currently have offerings in any specifically selected category.

As illustrated in FIG. 3, in one embodiment of the invention, the offering categories are linked to client system identifiers through a data table. It is to be understood that the client system identifiers may be linked to the client systems 110 through various data structures, methods, databases, and the like, and FIG. 3 is only meant to illustrate one embodiment of the invention and not limit the invention to a particular embodiment. By linking client system identifiers with each offering category, the server system 120 may provide a list of client system identifiers to the client system 110 upon query from the client system 110.

In one embodiment, the server system 120 indexes the list of seller client systems (“seller nodes”) maintained in the server system data structure. Indexing the seller nodes has several advantages. For example, by indexing seller nodes, the server system 120 may order or prioritize a list of seller nodes returned to a buyer client system. The seller nodes may be returned to the buyer client system ordered by the earliest seller to place an offering to the latest, or vise versa. Moreover, the list of seller nodes may be ordered by various priority or ordering criteria to advantageously present the list to the buyer client system. Also, by indexing the seller nodes, the server system 120 may search the server system data structure more quickly and efficiently.

B. Client System Data Structures

FIG. 4 schematically illustrates a client system data structure, according to aspects of an embodiment of the invention. As illustrated in FIG. 4, the client system 110 maintains data on the offerings and associated offering category. By maintaining an association between the offerings and the offering category, the client system 110 can provide a list of all offerings within an offering category to another client system 110 upon query by the other client system 110. It is to be understood that the offerings may be associated with offering categories through various data structures, methods, databases, and the like, and FIG. 4 is only meant to illustrate one embodiment of the invention and not limit the invention to a particular embodiment.

Moreover, the client system 110 maintains information relating to the offerings in the client database structures 230. For example, if an offering is a good, the client data structure 230 may maintain information regarding the good's description, condition, warranties, price, location, and the like. The client data structure 230 may also contain image, video, audio, hyperlink, and similar data to describe the good. As another example, if an offering is a service, the client data structure 230 may maintain information regarding the service's description, terms, conditions, warranties, price, and the like. The client data structure 230 may also contain image, video, audio, hyperlink, and similar data to describe the service.

### IV. Peer-To-Peer Processes

A. Placing an Offering for Sale or Auction

FIG. 5a illustrates a process by which a client system 110 places an offering for sale or auction, according to aspects of an embodiment of the invention. As illustrated, at a Step 505, the user of the client system 110 adds an offering for sale or auction. The client control module 220, the display module 210, and other software enable the user to create the description of, or search parameters for, an offering object that the user is seeking. The user may create an offering object and provide the parameters for that offering. For example, parameters of an offering may include offering category, description, price, location, terms, warranties, and the like. The information on the offering is maintained on the client system 110 by the client data structures 230. At a Step 510, the client system 110 determines if the offering added is the first one in the particular offering category of that that offering on the client system 110. The client system 110 may determine this by querying the client data structures 230. If, at the Step 510, the offering is not the first offering in the offering category on the client system 110, the process proceeds to a Step 525. If, at the Step 510, the offering is the first offering in the offering category on the client system 110, the process proceeds to a Step 515. At the Step 515, the client system 110 communicates to the server system 120 that a new offering category is being added to the client system 110, and the client system 110 sends the offering category to the server system 120. At a Step 520, the server system 120 updates the server data structures 270 to add the client system's identifier to the offering category. At the Step 525, the client data structures 230 on the client system 110 is updated to reflect the addition of the offering to the offering category. After the, Step 525, the process ends.

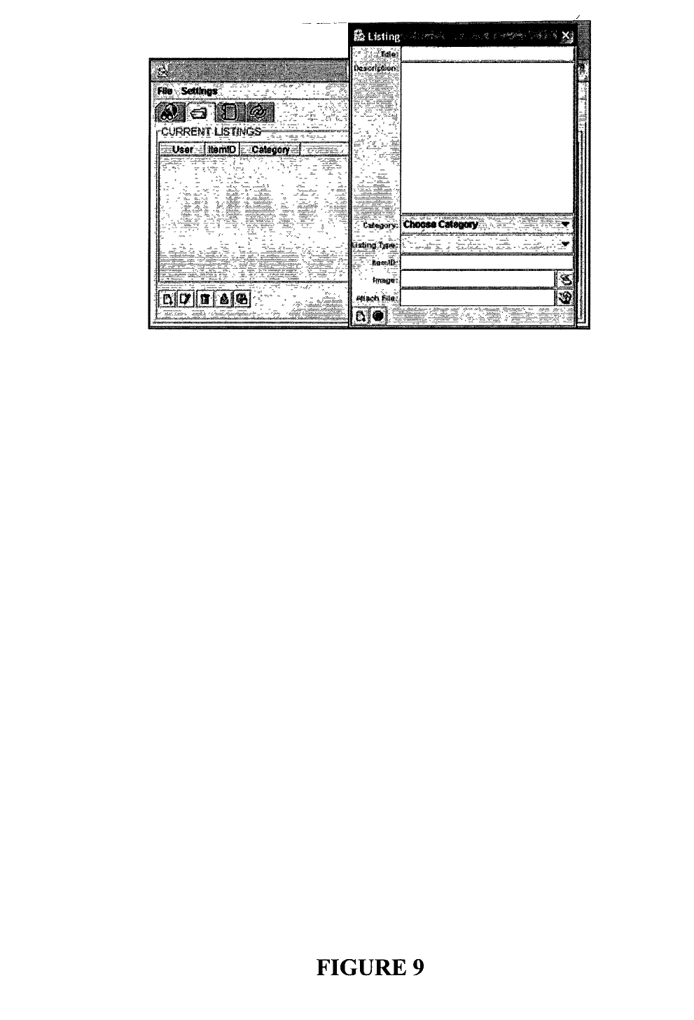

FIG. 9 illustrates a sample screen display of an offering display screen, according to aspects of an embodiment of the invention. As illustrated in FIG. 9, the offering display screen visually presents the offerings of the seller client system. Moreover, the offering display screen enables the user to modify the offerings and the associated offering information. Once an offering is added by the user, the offering display screen reflects that change.

As it can be seen, the client system 110 advantageously contacts the server system 120 when the user of the client system 110 has added an offering in a new offering category; therefore, contact with the server system 120 is reduced. Moreover, the data sent from the client system 110 to the server system 120 comprises the offering category, not the offering itself, thus reducing the amount of data to be sent over the network and the amount of data kept on the server system 120.

B. Removing an Offering for Sale or Auction

FIG. 5b illustrates a process by which a client system 110 removes an offering from sale or auction, according to aspects of an embodiment of the invention. As illustrated, at a Step 550, the user of the client system 110 removes an offering from sale or auction. The user may delete an offering upon the successful sale or auction, or for another reason. The user may remove the offering personally, or the offering may be removed by the client control module 220 upon the occurrence of an event or the expiration of a time limit. At a Step 555, the client system 110 determines if the offering removed is the last one in the particular offering category of the offering on the client system 110. The client system 110 may determine this by querying the client data structures 230. If, at the Step 555, the offering is not the last offering in the offering category on the client system 110, the process proceeds to a Step 570. If, at the Step 555, the offering is the last offering in the offering category on the client system 110, the process proceeds to a Step 560. At the Step 560, the client system 110 communicates to the server system 120 that an offering category is being removed from the client system 110, and the client system 110 sends the offering category to the server system 120. At a Step 565, the server system 120 updates the server data structures 270 to remove the client system's identifier from the offering category. At the Step 570, the client data structures 230 on the client system 110 is updated to reflect the removal of the offering from the offering category. After the Step 570, the process ends.

FIG. 9 illustrates a sample screen display of an offering display screen, according to aspects of an embodiment of the invention. As illustrated in FIG. 9, the offering display screen visually presents the offerings of the seller client system. Moreover, the offering display screen enables the user to modify the offerings and the associated offering information. Once an offering is removed by the user, the offering display screen reflects that change.

As it can be seen, the client system 110 advantageously contacts the server system 120 when the user of the client system 110 has removed the last offering in an offering category; therefore, contact with the server system 120 is reduced. Moreover, the data sent from the client system 110 to the server system 120 comprises the offering category, not the offering itself, thus reducing the amount of data to be sent over the network and the amount of data kept on the server system 120.

C. Search for Offering & Bidding

FIG. 6 illustrates a process by which a buyer client system locates an offering and places a bid or buy order for that offering, according to aspects of an embodiment of the invention. At a Step 605, the user of a client system (the buyer client system) prepares the search for a desired offering purchase, and the client system 110 sends a query to the server system 120 comprising the offering category of the desired offering for purchase. FIG. 8 illustrates a sample screen display of a query screen, according to aspects of an embodiment of the invention. The user may use the query screen to enter the search parameters for the desired offering for purchase. At a Step 610, the server system 120 uses the offering category provided by the client system 110 to search the server data structures 270. Using the offering category, the server system 120 determines the list of client system identifiers, that have offerings listed in the selected category, if any. At a Step 615, the server system 120 sends the list of client system identifiers to the buyer client system. If there are no client system identifiers in the offering category, the server system 120 sends a message to the buyer client system to indicate that the search had no results, and the process ends. At a Step 620, the buyer client system presents the list of the client system identifiers to the user of the buyer client system, through a display screen such as illustrated in FIG. 8. The user selects a client system (the seller client system) from the list of client system identifiers provided by the server system 120.

At a Step 625, the buyer client system queries the seller client system, without the query passing through the server system 120, to request information on offerings in the offering category, and for a description of the offerings. In the request for information, the buyer client system includes the offering category. At a Step 630, using the offering category provided by the buyer client system, the seller client system queries the client data structures 230 on the seller client system to retrieve the offerings in the offering category. The seller client system sends the offerings and the offerings' descriptions to the buyer client system.

At a Step 640, the buyer client system receives the information from the seller client system, and the user of the buyer client system decides to place a bid or a buy order on the offering. If the user of the buyer client system decides to not place a bid or a buy order on the offering, the process ends. If the user of the buyer client system decides to place a bid or a buy order on the offering, the process proceeds to a Step 645. At the Step 645, the buyer client system sends a buy order or a bid to the seller client system without the involvement of the server system 120. At a Step 650, the seller client system 650 receives the buy order or bid from the buyer client system. In one embodiment of the invention, the seller client system provides a confirmation of the buy order or the auction completion to the server system 120 and to the buyer client system. At the completion of the Step 650, the process ends.

While this description describes a scenario where a buyer is seeking an offering for acquisition, it is to be understood that the process can be used for other purposes. For example, the process may be used to obtain information on offerings, sellers of offerings, availability of offerings, number of offerings available in an offering category, and other purposes.

Thus, the preferred embodiment of the system described herein advantageously “pushes” the majority of the computer processing functions away from the server system and to the buyer and seller nodes. The server system includes substantially no data regarding specific products or services for sale. The server system does not search any databases of specific products or services for sale. These functions are left to the buyer and seller client systems. This reduces the amount of work the server system does. Preferably, the server system provides substantially or absolutely no information regarding specific products or services for sale or barter to the buyer and seller client systems.

### V. Peer-To-Peer Communications

As disclosed herein, peer-to-peer electronic commerce allows for the buyer client system and the seller client system to communicate offering information and enter into a transaction without the intervention or use of the server system 120. To facilitate the communication between the buyer client system and the seller client system, the invention provides various communication systems such as online chat and online whiteboard.

A. Online Chat Between Buyer Client System and Seller Client System

Generally, online chat is a process by which two or more computer users on the Internet communicate to each other at the same time. Usually, “chatting” is the exchange of typed-in messages requiring one site as the repository for the messages (“chat site”) and a group of users who take part from anywhere on the Internet. In some cases, a private chat can be arranged between two parties who meet initially in a group chat. Chats can be ongoing or scheduled for a particular time and duration. Some chats are focused on a particular topic of interest, and generally, transcripts of a chat can be archived for later reference. Chats are usually conducted on online services, such as AOL, by bulletin board services, and by Web sites. A chat can also be conducted using sound, video, images, hyperlinks, and the like. Generally, a client system hosts the chat while one or more client systems may join in a chat. Moreover, a client system may join a chat already in progress between two other client systems.

One aspect of the system is a chat system that enables the client systems 110 to communicate with each other. The chat system advantageously allows for the buyer client systems to ask for and receive information from the seller client system on an interactive and real-time basis. Other advantages include the buyer and seller being able to negotiate a price, terms, delivery terms, warranties, and the like on an interactive and real-time basis.

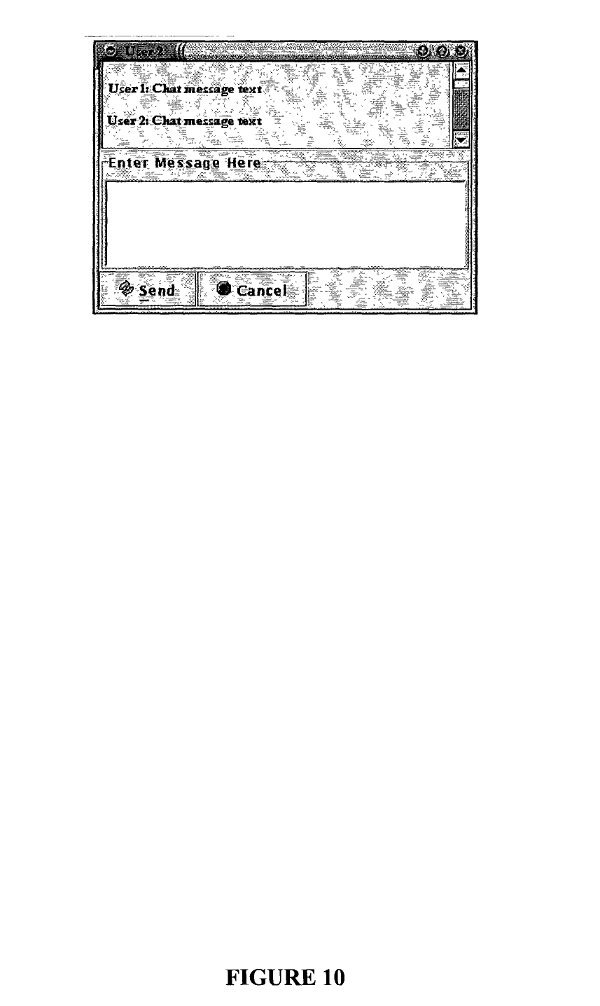

FIG. 10 illustrates a sample screen display of an online chat screen, according to aspects of an embodiment of the invention. As illustrated in FIG. 10, the online chat screen enables users to enter chat messages on the screen and send that message to another user by pressing the “Send” button. If the user decides to end the chat session, the user may press the “Cancel” button or close the online chat screen through the window button. As it can be seen, that the online chat screen allows buyers and sellers to communicate more freely, directly, and specifically with one another, thus promoting electronic commerce between buyers and sellers.

B. Online Whiteboard

Generally, a whiteboard is a medium on which ideas and communication can take a graphical form. One aspect of the system is an online whiteboard system that enables the client systems 110 to communicate with each other. The online whiteboard system advantageously allows for the seller client systems to describe their offerings to buyer client systems using text, graphics, pictures, and other forms of expression. Moreover, the online whiteboard enables the seller client system and the buyer client system to communicate on an interactive and real-time basis. Other advantages include the buyer and seller being able to visually discuss various aspects of the offering, and if desired, focus on a particular aspect of the offering through the use of the online whiteboard. For example, if the seller client system is offering a car for sale, the buyer client system may view a picture of the car through the online whiteboard. Moreover, the buyer client system can visually outline any questions and concerns with the car to the seller client system on a real-time and interactive manner. The seller client system can respond to those questions and concerns visually, while the buyer client system is still online.

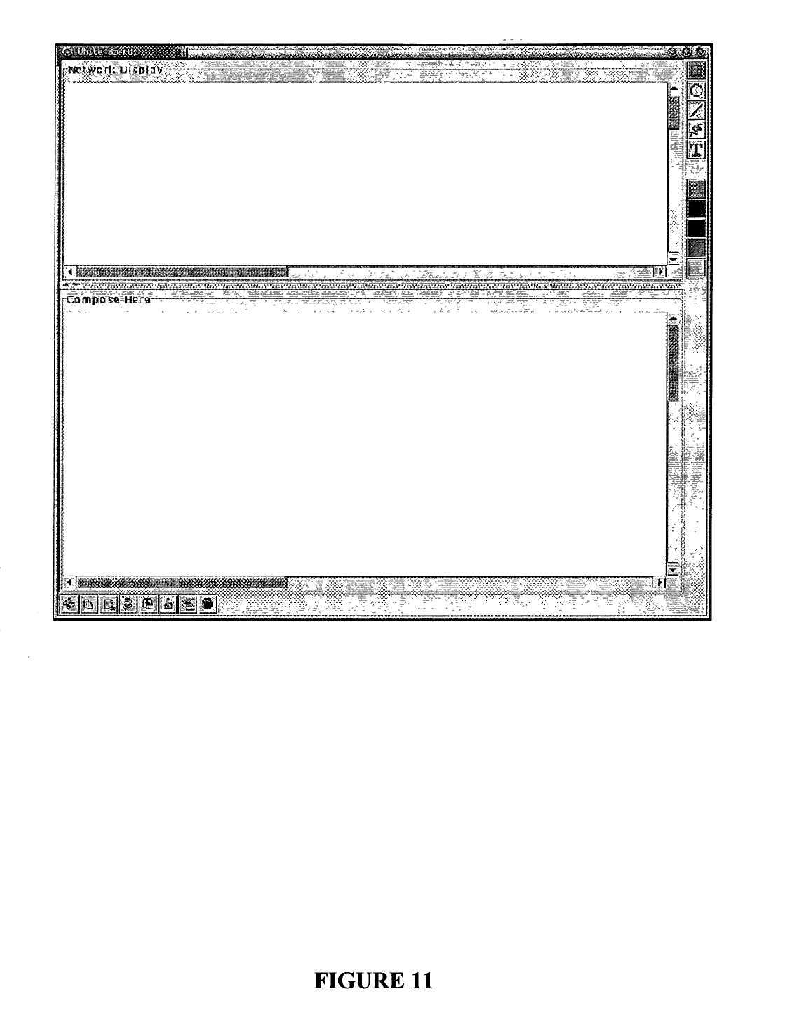

FIG. 11 illustrates a sample screen display of an online whiteboard screen, according to aspects of an embodiment of the invention. As illustrated in FIG. 11, the online whiteboard enables users to communicate graphically with one another to promote electronic commerce and transactions between the users. In one embodiment, as shown in FIG. 11, a user may compose a graphical communication in the “Compose Here” section of the online whiteboard. The user may use various tools of the online whiteboard to compose the graphic before submitting to another user. In one embodiment, once the graphic created by the user is communicated to another user, the graphic is displayed in the “Network Display” section of the online whiteboard. The “Network Display” section shows what the recipient of the communication sees. As it can be seen, the online chat screen allows buyers and sellers to communicate more freely, directly, and specifically with one another using graphics and pictures, thus promoting electronic commerce between buyers and sellers.

While the foregoing detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method of performing a transaction, comprising:
receiving item information associated with items for sale from a plurality of seller client systems;
maintaining the item information on a server system;
maintaining identifications of each of the seller client systems associated with each of the items for sale on the server system;
receiving a query from a buyer client system, wherein the query comprises search criteria for a desired item for purchase;
preparing a list of identifications of each of the seller client systems that satisfy the search criteria; and
sending the list of identifications of each of the seller client systems to the buyer client system.

2. A method of performing electronic commerce over a computer network, comprising:
maintaining a data structure comprising a list of categories of offerings by a plurality of seller client systems;
receiving a query from a buyer client system, wherein the query comprises a search criteria;
determining an offering category associated with the search criteria;
preparing a list of one or more of said seller client systems associated with the offering category; and
sending the list of one or more of said seller client systems to the buyer client system.

3. The method of claim 2, wherein an offering associated with the search criteria comprises a good.

4. The method of claim 2, wherein an offering associated with the search criteria comprises a service.

5. The method of claim 2, further comprising;
receiving a buy order confirmation from a selected one of said one or more the seller client system wherein the buy order confirmation relates to an offering by the selected seller client system to the buyer client system; and
updating the data structure according to the buy order confirmation.

6. The method of claim 2, further comprising;
receiving an auction completion confirmation from a selected one of said one or more seller client systems, wherein the auction completion confirmation relates to an offering by the selected seller client system to the buyer client system; and
updating the data structure according to the auction completion confirmation.

7. A method of locating an offering over a computer network, comprising:
defining a search criteria associated with the offering;
sending the search criteria over the computer network to a server system;
receiving a list of one or more seller client systems associated with the search criteria;
sending a query to one of the one or more seller client systems requesting information on an offering for sale satisfying the search criteria; and
receiving information on the offering for sale from the seller client system.

8. The method of claim 7, wherein requesting information on an offering for sale satisfying the search criteria comprises requesting said seller client system to search a data structure of the seller client system.

9. The method of claim 7, further comprising:
sending a buy order to the seller client system; and
receiving a message associated with the buy order from one or both of the seller client system and the server system.

10. The method of claim 7, further comprising:
sending a bid to the seller client system; and
receiving a message associated with the bid from one or both of the seller client system and the server system.

11. The method of claim 7, wherein sending the search criteria to the server system comprises using a World Wide Web browser.

12. A method of placing an offering for acquisition over a computer network, comprising:
assigning one of a plurality of offering category designations to the offering;
sending the assigned offering category designation over the computer network to a server system; and
receiving a query from a buyer client system requesting information associated with the offering.

13. The method of claim 12, further comprising:
querying a local data structure for information associated with the offering; and
sending the information associated with the offering to the buyer client system.

14. The method of claim 13, further comprising:
receiving a buy order from the buyer client system.

15. The method of claim 13, further comprising:
receiving an auction bid from the buyer client system.

16. A method of placing offerings for sale over a computer network, comprising:
assigning one of a plurality of offering category designations to each of one or more offerings for sale;
sending the assigned offering category designation over the computer network to a server system; and
receiving a query from a buyer client system requesting information associated with a selected one of the offering category designations.

17. The method of claim 16, further comprising:
querying a local data structure for offerings for sale that have been assigned the selected category designation; and
sending the offerings for sale that have been assigned the selected category designation to the buyer client system.

18. The method of claim 17 further comprising:
receiving a buy order from the buyer client system.

19. The method of claim 17 further comprising:
receiving an auction bid from the buyer client system.

20. A computer system for performing a sales transaction, comprising:
a plurality of seller client systems each identified by a seller client system identifier;
a plurality of offerings associated with one of the seller client systems;
a plurality of categories of offerings, each of the offerings being associated with at least one of the offerings;
a buyer client system; and
a server system comprising a category of offerings data structure comprising one or more of said categories of offerings and one or more of said seller client system identifiers, wherein the buyer client system is configured to send a query to the server system to locate a desired offering, the server system is configured to determine at least one of the categories of offerings satisfying the query, the server system is further configured to query the category of offerings data structure to determine a list of send the seller client system identifiers associated with the determined at least one category, and the server is further configured to send the list of seller client system identifiers to the buyer client system.

21. The computer system of claim 20, wherein the buyer client system is configured to send communication to one of the seller client systems associated with the list of seller client system identifiers, requesting the seller client system to send information regarding the offering.

22. The computer system of claim 21, wherein the seller client system is configured to search local data structure for said information regarding the offering and send said information regarding the offering to the buyer client system.

23. The computer system of claim 22, wherein the buyer client system is configured to send bid or buy order to seller client system.

24. The computer system of claim 20, wherein the seller client system is further configured to send a buy confirmation to the server system and the server system is further configured to update the category of offerings data structure.

25. The computer system of claim 20, wherein the seller client system is further configured to send an auction completion confirmation to the server system and the server system is further configured to update the category of offerings data structure.

26. A computer system for performing a commerce transaction, comprising:
a communications module configured to receive offering information associated with an offering from one of a plurality of seller client systems, wherein each seller client system is identified by a seller client system identifier;
a category of offerings data structure comprising one or more offering categories and one or more of said seller client system identifiers; and
a control module configured to maintain the category of offerings data structure, wherein the control module is further configured to provide one or more of said seller client system identifiers to a buyer client system in response to a query from the buyer client system.

27. The computer system of claim 26, wherein the communications module is further configured to receive a buy confirmation from one of the seller client systems and to update the category of offerings data structure according to the buy confirmation.

28. The computer system of claim 26, wherein the communications module is further configured to receive an auction completion confirmation from one of the seller client systems and to update the category of offerings data structure according to the auction completion confirmation.

29. A computer system for performing a commerce transaction, comprising:
offering information associated with an offering; and
a communications module configured to send the offering information to a server system and to receive a buy order or an auction bid directly from a buyer client system.

30. The computer system of claim 29 wherein the communications module is further configured to send a buy confirmation or an auction completion confirmation to the server system.

31. A computer system for performing a commerce transaction, comprising:
a query comprising offering information describing a desired offering; and
a communications module configured to send the query to a server system, wherein the communications module is further configured to receive one or more seller client system identifiers associated with the offering information from the server system.

32. The computer system of claim 31, wherein the communications module is further configured to send a query to a seller client system identified by the seller client system identifier.

33. The computer system of claim 31, wherein the communications module is further configured to send a buy order to the seller client system.

34. The computer system of claim 31, wherein the communications module is further configured to send an auction bid to the seller client system.
